(19) United States
(12) Patent Application Publication
(10) Pub. No.: US 2009/0049423 A1
(43) Pub. Date: Feb. 19, 2009

(54) JAVASCRIPTTM PROGRAMMING EXTENSION

(75) Inventors: Yitao Yao, Saratoga, CA (US); Justin Christopher Early, San Jose, CA (US); Gregory Choi, San Jose, CA (US); Mark P. Palaima, Saratoga, CA (US)

Correspondence Address: SCHWEGMAN, LUNDBERG & WOESSNER, P.A., P.O. BOX 2938, MINNEAPOLIS, MN, 55402, US

(73) Assignee: eBay Inc., San Jose, CA (US)

(21) Appl. No.: 12/176,244

(22) Filed: Jul. 18, 2008

Related U.S. Application Data
(60) Provisional application No. 60/961,647, filed on Jul. 23, 2007.

(51) Int. Cl. G06F 9/44

(52) U.S. Cl. 717/108; 717/106

(57) ABSTRACT

A JavaScript™ programming extension is provided. An example JavaScript™ programming extension comprises a code generator and a JavaScript™ reference converter. The code generator may be configured to access an existing JavaScript™ file, validate JavaScript™ definitions in the existing JavaScript™ file, and generate a Java™ representation of the existing JavaScript™ file. The JavaScript™ reference converter may be configured to generate a validated JavaScript™ file corresponding to the existing JavaScript™ file.

### RELATED APPLICATIONS

This application is related to and hereby claims the priority benefit of U.S. Provisional Patent Application No. 60/961,647 filed Jul. 23, 2007 and entitled “JAVASCRIPT PROGRAMMING EXTENSION”, which application is incorporated herein by reference in its entirety.

### TECHNICAL FIELD

This application relates to a JavaScript™ programming extension.

### BACKGROUND

JavaScript™ is a scripting language that is used for client-side web development. Despite its name, and while designed to look like Java™, JavaScript™ is unrelated to the Java™ programming language. Rather, JavaScript™ is a dynamic, weakly typed, prototype-based language intended to be easier for non-programmers to work with. “JavaScript™” is a trademark of Sun Microsystems.

In the past twelve years, JavaScript™ (JS) has been a de facto client-side scripting language for web pages. With the adoption of Web-2.0 for supporting rich client experience without sacrificing the easy accessibility of web application over WAN, the JavaScript™ programming in connection with cascading style sheets (CSS) and Markup language become a focal point of many web-technology efforts.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example JavaScript™ programming extension may be implemented;

FIG. 2 is block diagram of a system to provide a JavaScript™ programming extension, in accordance with one example embodiment;

FIG. 3 is a flow chart of a method to provide a validated JavaScript™ to a browser application, in accordance with an example embodiment;

FIG. 4 is a flow chart of a method to generate a validated JavaScript™, in accordance with an example embodiment; and

FIG. 5 is a diagrammatic representation of an example machine in the form of a computer system within which a set of instructions, for causing the machine to perform any one or more of the methodologies discussed herein, may be executed.

### DETAILED DESCRIPTION

A JavaScript™ programming extension is described. In the following description, for purposes of explanation, numerous specific details are set forth in order to provide a thorough understanding of an embodiment of the present invention. It will be evident, however, to one skilled in the art that the present invention may be practiced without these specific details.

Several open-source and commercial projects had attempted to enhance the JavaScript™ programming model in recent years. Most of them provide a thin layer of abstraction to support componentized JavaScript™ programming and to isolate browser incompatibility in terms of native events. There have also been some attempts to have a complete server-side construct to facilitate an active programming in Java™ to produce JavaScript™ for the client runtime. However, due to the language incompatibilities between Java™ and JavaScript™, as well as runtime difference (server virtual machine (VM) and client browser), there is still no proven clean and simple server-side programming model. A set of client-side-centric widget kits have been introduced recently that boast componentization approaches and the ease of use.

However, all those attempts didn't address a number of issues that were identified by the inventors of the JavaScript™ programming extension. Some of these issues identified by the inventors are outlined below. For example, existing technologies lack clean server-side application programming interface (API) for referencing client-side JavaScript™ components, which pushes the client-side-script referencing to be a set of string-concatenation operations in the server side without any type/API validation at compile time and runtime. Furthermore, there is no direct support available for transformation from non-typed JavaScript™ API to typed Java™ API, which makes it difficult to directly use typed data in server-side programming when referencing client-side JavaScript™ components.

Another deficiency identified by the inventors is the lack of systematic dependency management for using client-side JavaScript™ components, which makes JavaScript™ bundling/externalization difficult. The inventors also identified the lack of systematic approach for controlling JavaScript™ scope mash-up applications fragile, e.g., due to possible naming conflicts at runtime. Because there is no support for running multiple JavaScript™ runtimes/frameworks on same page, migration of JavaScript™ components may prove very difficult if the content of a web page come from different servers, because the server-side JavaScript™ generation could be based on different JavaScript™ runtime/frameworks at different servers. For example, the content of a web page may be provided, e.g., via (a) server-side page assembly for portal pages, (b) client-side page assembly, or (c) AJAX calls.

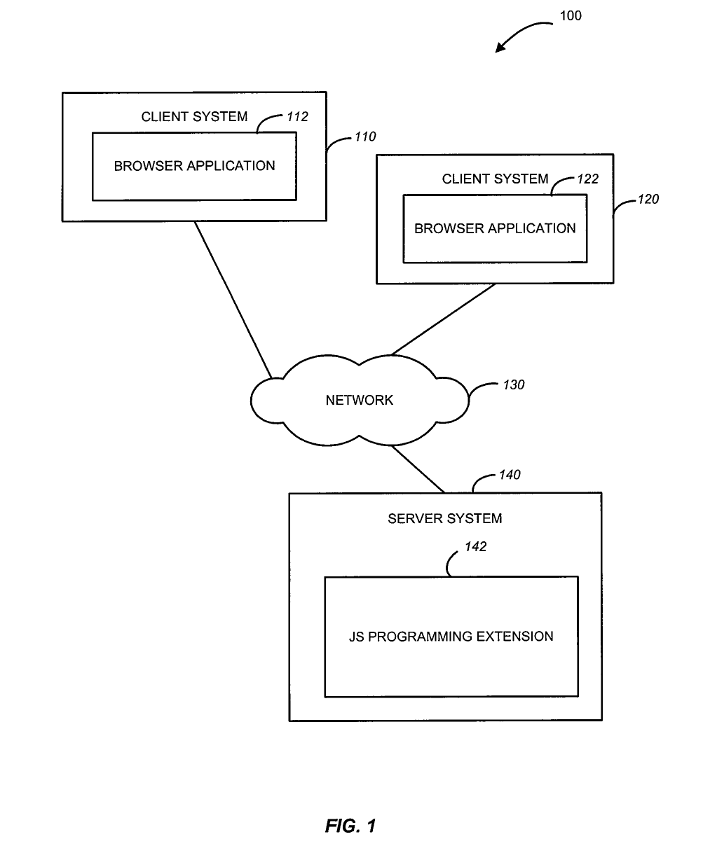

In one example embodiment, a JavaScript™ programming extension is implemented in Java™ with smooth integration of integrated development environment (IDE), such as, e.g., Eclipse. An example JavaScript™ programming extension may be utilized to provide satisfactory solutions to the above mentioned problems identified by the named inventors. An example contract-centric system may be implemented in the context of a network environment 100 illustrated in FIG. 1.

As shown in FIG. 1, the network environment 100 may include client systems 110 and 120 and a server system 140. The server system 140, in one example embodiment, may host a network-based transaction facility. The client systems 110 and 120 may run respective browser applications 112 and 122 and may have access to the server system 140 via a communications network 130. The communications network 130 may be a public network (e.g., the Internet, a wireless network, etc.) or a private network (e.g., a local area network (LAN), a wide area network (WAN), Intranet, etc.).

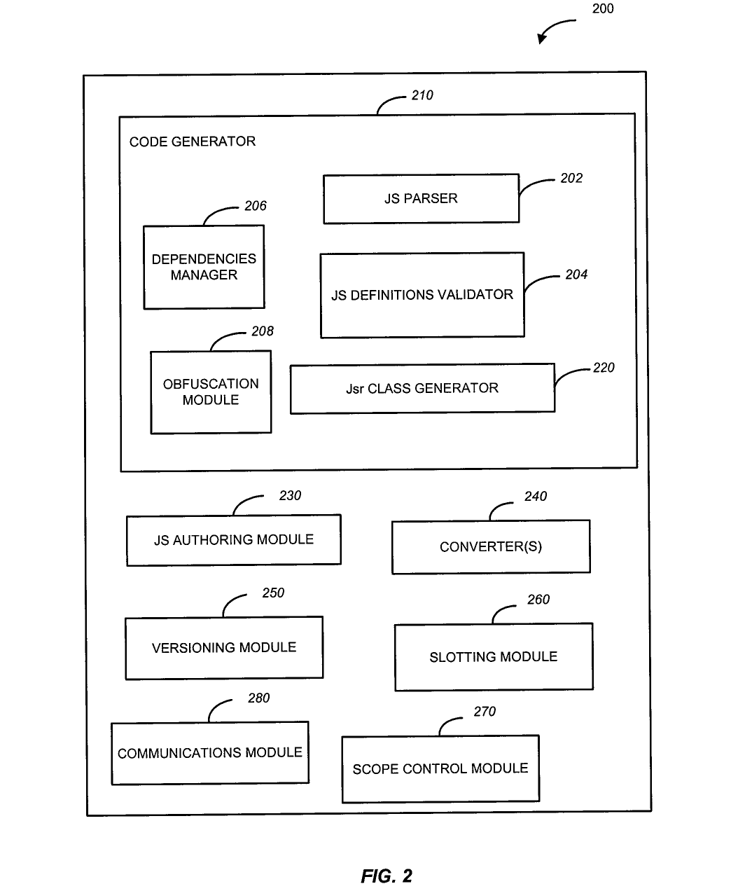

The client system 110 may utilize the browser application 112 to access services provided by the server system 140. The server system 140 may employ a JavaScript™ programming extension 142, e.g., to access a JavaScript™ file, validate JavaScript™ definitions in the JavaScript™ file, and to generate a Java™ representation of the JavaScript™ file. An example system to provide a JavaScript™ programming extension is illustrated in FIG. 2.

FIG. 2 is a block diagram of a system 200 to provide a JavaScript™ programming extension, in accordance with one example embodiment. As shown in FIG. 2, the system 200 includes a code generator 210, a JavaScript™ authoring module 230, converters 240, a versioning module 250, a slotting module 260, a scope control module 270, and a communications module 280. The code generator, in turn, may comprise a JavaScript™ parser, 202, a JavaScript™ definitions validator 204, a dependencies manager 206, an obfuscation module 208, and a Jsr class generator 220.

The code generator 210, in one example embodiment, may be configured to access an existing JavaScript™ file, validate JavaScript™ definitions in the existing JavaScript™ file (e.g., by utilizing the JavaScript™ parser 202 and the JavaScript™ definitions validator 204), and to invoke the Jsr class generator to generate Jsr class for the existing JavaScript™ file. The generated Jsr class embodies a Java™ representation of the existing JavaScript™ file. a Java™ representation of the existing JavaScript™ file. The set of converters 240, which may be referred to as a JavaScript™ reference converter, may be configured to generate a validated JavaScript™ corresponding to the existing JavaScript™. The dependencies manager 206, may be configured to maintain one or more dependencies among one or more JavaScript™ components in the validated JavaScript™ file. the communications module 280 may be configured to provide a validated JavaScript™ file to a browser application.

It will be noted, that while FIG. 2 shows particular modules as part of the code generator 210, some of these modules, e.g., the dependencies manager 206, may be implemented to not reside within the code generator 210.

An example of server-side JavaScript™ referencing is discussed below. In one example embodiment, a JavaScript™ referencing programming model is provided at the server side. A JavaScript™ referencing programming model may be implemented within the system 200 of FIG. 2 described above. Example technologies that have been derived in order to provide a JavaScript™ referencing programming model at the server side are discussed below. A light-weight JavaScript™ runtime (framework) to support Object-Oriented component programming style with JavaScript™; concept of library, package, class, interface, imports, public/private, static/instance and extends, etc. are all supported in one example embodiment. JsDoc annotation may be used to declare both JavaScript™ and Java™ data types for all APIs. A code-generation tool may be configured to validate JavaScript™ definitions via extended JavaScript™ engine and generate typed JavaScript™ referencing class (Jsr) in Java™ for every JavaScript™ component. Example code-generation tool is illustrated as the code generator 210 is FIG. 2. A code-generation tool can be run as a pre-build-code-gen ant task or a part of IDE plug-in.

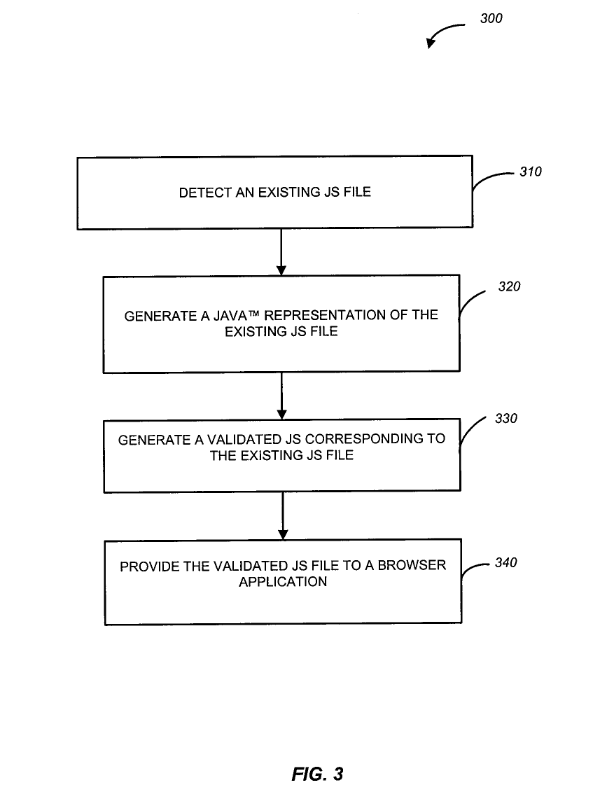

The generated JavaScript™ referencing class, e.g., the Jsr class generated by the Jsr class generator 220 of FIG. 2, may support a natural server-side programming paradigm, such as, instance creation/initialization, object/reference passing and sharing. The generated APIs, in one example embodiment, mirror their corresponding JavaScript™ functions, but with typed Java™ data type for both arguments and return types. A set of build-in converters (e.g., the converters 240 of FIG. 2) may be configured to convert Java™ data type to JavaScript™ data type internally for JavaScript™ code-gen at server runtime. For example, Java™ Date can be converted to either string, long or JSDate, depending on JsDoc definition. An open architecture allows pluggable converters in the system for handling any Java™ data types. The converters may thus be invoked to generate a validated JavaScript™ from the Java™ representation of the original JavaScript™ (from a Jsr object). An example method to provide a validated JavaScript™ to a browser application can be described with reference to FIG. 3.

FIG. 3 is a flow chart of a method 300 to provide a validated JavaScript™ to a browser application, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system to provide a JavaScript™ programming extension 200 shown in FIG. 2.

As shown in FIG. 3, an existing JavaScript™ file is detected at operation 310. At operation 320, the code generator 210 of FIG. 2 generates a Java™ representation of the existing JavaScript™ file (e.g., in the form of a Jsr object, where Jsr is a typed referencing class). In some embodiments the generating of a Java™ representation of a source JavaScript™ file includes validating all definitions in the source JavaScript™ file, which makes it possible to convert the Java™ representation of a source JavaScript™ file into a validated JavaScript™ file that corresponds to the source JavaScript™ file (operation 330). At operation 340, the communications module 280 of FIG. 2 provides the validated JavaScript™ file to a browser application, where it may be interpreted and executed by a JavaScript™ engine.

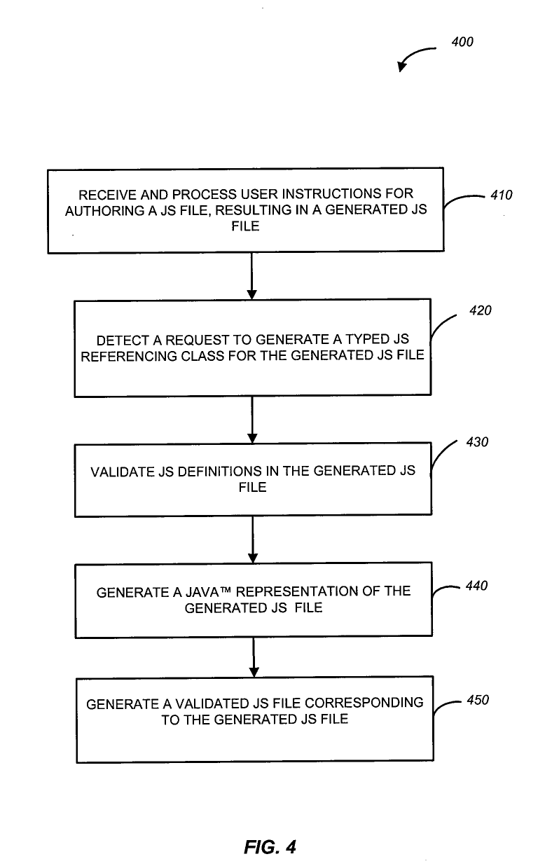

As mentioned above, with reference to FIG. 2, a system to provide a JavaScript™ programming extension may include a JavaScript™ authoring module to permit authoring of JavaScript™ files. these files may then be processed by an associated Java™ code generator (e.g., the code generator 210 of FIG. 2) and converted (e.g., by the converter 240) into a validated JavaScript™ file. FIG. 4 is a flow chart of a method 400 to generate a validated JavaScript™, in accordance with an example embodiment.

The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system to provide a JavaScript™ programming extension 200 shown in FIG. 2.

As shown in FIG. 4, at operation 410, the system 200 receives and processes user's instructions for authoring a JavaScript™ file. The result of the operation 410 is a generated JavaScript™ file. At operation 420, the code generator 210 of FIG. 2 detects a request to generate a typed JavaScript™ referencing class (a Jsr object) for the generated JavaScript™ file. The code generator 210 invokes the JavaScript™ definitions validator 204 of FIG. 2 that, in turn, validates JavaScript™ definitions in the generated JavaScript™ file at operation 430. At operation 440, the Jsr class generator 220 of FIG. 2 generates a Java™ representation of the generated JavaScript™ file. The converter 240 of FIG. 2 generates a validated JavaScript™ script at operation 450. The validated JavaScript™ file corresponds to the generated JavaScript™ file.

One example feature of a JavaScript™ reference model is value-binding support. All generated Java™ functions can take typed-value-binding as their arguments, and the return type from a method invocation is also a typed-value-binding. Therefore, one can naturally pass function calls as other function's arguments, even though these function calls would produce JavaScript™ referencing code at server side instead of real values. In addition to general JavaScript™ components, more specific JavaScript™ object types may be enabled. Such specific object types, e.g., event handler and service request/response handlers may be supported in an example JavaScript™ reference model when other add-on runtime services (such as, e.g., EventDispater and ClientServiceEngine) enabled.

In one example embodiment, dependencies between JavaScript™ components may be automatically maintained via generated component spec based on JavaScript™ import/require statements. The dependencies may be maintained utilizing a dependencies manager 206 of FIG. 2. Maintaining dependencies may be utilized beneficially to enable generic JavaScript™ aggregation and externalization. An example of JavaScript™ referencing is provided below.

Static Java™ Invocation:

Java™:
A.foo(aMinValue, aMaxValue, B.bar(aDate, 2));

Generated JavaScript™:
A.foo(12.5, 40, B.bar(new Date(99988822), 2));

Example JavaScript™ scope is discussed below. In order to support multiple runtimes, as well as general mash-up applications, a standardized runtime scoping mechanism may be provided (e.g., utilizing the scope control module 270 of FIG. 2), in accordance with one example embodiment. Utilizing a dynamic scoping mechanism may permit different versions of same JavaScript™ component to function simultaneously on same page without overriding each other. This approach may be beneficial for managing JavaScript™ naming resolution for mash-up application, where JavaScript™ naming conflict is more likely to occur for normal page assembly.

Example ID generation and naming reservation is discussed below. In order to support JavaScript™ component's instantiation, initialization and referencing without requiring unique variable assignment in generated JavaScript™ code, an example Java™ Script Programming Extension optionally uses server-side IdGenerator to uniquely register component instances to client-side Registry. The IdGenerator can be scoped to avoid naming conflict form different dynamic page fragments, such as those from remote portlets. The scope name can be reserved via naming reservation system, which ensures that only the reservee, who reserves the name from a reservor in a domain, can access that value. Each reservor may be required to guarantee the uniqueness of the reservation ticket. Domain specific reservor can also obtain its own scope (prefix) from a global reservor in order to avoid naming conflict at large scale.

Example control of obfuscation and verbosity is discussed below. In one example embodiment, all JavaScript™ code is retrieved or generated at server side either at build time or at runtime. The standard access pattern for JavaScript™ resource provides complete control on the final form of JavaScript™, both in aggregated external JavaScript™ files and in-line JavaScript™ on the pages. Obfuscation can be applied to all or some JavaScript™ for eliminating comments, JsDocs and extra spaces, as well as for obfuscating variable names, etc. Obfuscation may be performed by the obfuscation module 208 of FIG. 2. Verbose state allows additional information being injected into the final aggregated/generated JavaScript™, which provides complete traceability to the sources of component JavaScript™ and their contributors.

Example JavaScript™ Resource Slotting is discussed below. In order to permit controlling of the JavaScript™ ordering and physical locations on a page and to achieve desired functional and performance characteristics, according to one example embodiment, a generic logical slotting mechanism had been provided. The slotting mechanism, implemented in one embodiment as the slotting module 260 of FIG. 2 is separate from the physical applier. This approach enables general aggregation/de-duping in more complex programming environment, such as portal application. It also supports pre-aggregation at build time for the JavaScript™ externalization.

Example JavaScript™ Externalization and Versioning is discussed below. In one example embodiment, a generic JavaScript™ resource extraction/aggregation mechanism has been derived to pre-aggregate system runtime JavaScript™ libraries as well as page-level JavaScript™ files. The versioning strategy via deployed table of content, that may be implemented via the versioning module 250 of FIG. 2, may achieve some or all of the results mentioned below. For example, running application can auto-discover new compatible version of JavaScript™ files it references to for its web-page production, therefore quicker JavaScript™ bug fix can be applied without rebuild/redeploy/restart the application. The efficient versioning strategy can force browser cache to fetch most-updated version, while reducing the number of unique version in the caches at both browsers and caching servers.

Example Integrated Development and Testing is discussed below. An example JavaScript™ Programming Extension JS-to-Java™ code generation may be integrated with a popular IDE-Eclipse. Both on-demand and auto code-gen may be supported via Eclipse plug-in. A standard ant task enables pre-build step for Jsr generation based on JavaScript™ files.

The techniques described herein may be utilized beneficially. e.g., in component JavaScript™ testing.

Example Runtime JavaScript™ Builder is discussed below. In order to support debug and testing over deployed application, one can proxy the external JavaScript™ links to a local IDE to rebuild the JavaScript™ with either verbose form or with new fixes without requiring any production re-roll.

Example JavaScript™ programming extension may be utilized advantageously in the context of server-side-centric web application development with Java™ or other languages, such as. e.g., .net, C++, etc. Example JavaScript™ programming extension may contribute to adoption of existing JavaScript™ widgets by providing server-side JavaScript™ referencing model via some example Java™ Script Programming Extension wrappers.

Machine readable medium will be understood as a medium that is capable of storing data in a form that can be accessed by an automated sensing device. Examples of machine-readable media include magnetic disks, cards, tapes, and optical disks, as well as other forms of volatile and non-volatile memory devices.

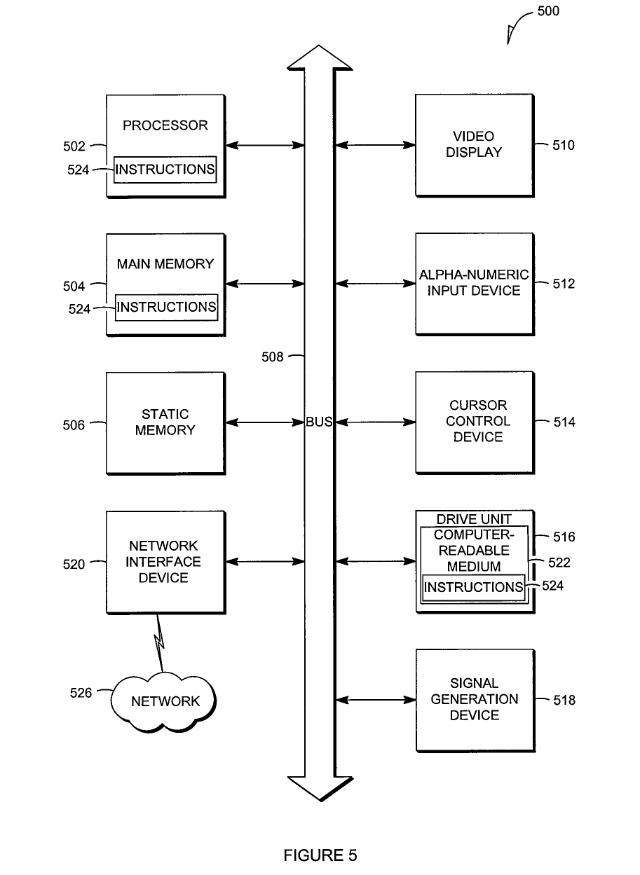

FIG. 5 shows a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of embodiments of the present invention, or that is capable of storing, encoding or carrying data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware.

Thus, a programming extension for authoring style rules has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

What is claimed is:

1. A system comprising:
a code generator to:
access an existing JavaScript™ file;
validate JavaScript™ definitions in the existing JavaScript™ file, and
generate a Java™ representation of the existing JavaScript™ file; and
a JavaScript™ reference converter to generate a validated JavaScript™ corresponding to the existing JavaScript™.

2. The system of claim 1, including a JavaScript™ authoring module to facilitate authoring of JavaScript™ files.

3. The system of claim 2, wherein the JavaScript™ authoring module comprises a JavaScript™ runtime framework to support object-oriented component programming style with JavaScript™.

4. The system of claim 2, wherein the JavaScript™ authoring module supports JsDoc annotation to declare data types.

5. The system of claim 1, wherein the Java™ representation of the existing JavaScript™ file comprises a typed referencing class in Java™ for each JavaScript™ component in the existing JavaScript™ file.

6. The system of claim 4, wherein the code generator is to provide value-binding support.

7. The system of claim 1, wherein the JavaScript™ reference converter comprises one or more converters to convert Java™ data type into JS-compatible data type.

8. The system of claim 7, wherein the one or more converters include a date converter to convert a Java™ Date type into a JavaScript™ compatible type.

9. The system of claim 1, further comprising a dependencies manager to maintain one or more dependencies among one or more JavaScript™ components in the validated JavaScript™ file.

10. The system of claim 1, wherein the system is integrated with an Integrated Development Environment (IDE).

11. A method comprising:
accessing an existing JavaScript™ file;
validating JavaScript™ definitions in the existing JavaScript™ file; and
generating a Java™ representation of the existing JavaScript™ file.

12. The method of claim 11, wherein the Java™ representation of the existing JavaScript™ file is a Java™ class.

13. The method of claim 11, further comprising generating a validated JavaScript™ file corresponding to the existing JavaScript™.

14. The method of claim 14, further comprising obfuscating the contents of the validated JavaScript™ file module to impede readability of the validated JavaScript™ file.

15. The method of claim 14, wherein the generating of the validated JavaScript™ file comprises converting a Java™ data type into a JavaScript™ data type.

16. The method of claim 15, wherein the a Java™ data type is a Java™ date type and the JavaScript™ data type is one of “string”, “long”, and JSDate.

17. The method of claim 11, wherein the Java™ representation of the existing JavaScript™ file includes a Java™ function that can take typed-value-binding as an argument and return a value that is also a typed-value binding.

18. The method of claim 11, further comprising:
determining dependencies between JavaScript™ components in the existing JavaScript™ file; and
maintaining the determined dependencies to enable JavaScript™ aggregation and externalization.

19. The method of claim 11, further comprising facilitating authoring of the existing JavaScript™ file including building dependencies for the existing JavaScript™ file.

20. A machine-readable medium having instruction data to cause a machine to:
access an existing JavaScript™ file;
validate JavaScript™ definitions in the existing JavaScript™ file;
generate a Java™ representation of the existing JavaScript™ file; and
generate a validated JavaScript™ corresponding to the existing JavaScript™.
